(19) United States
(12) Patent Application Publication
(10) Pub. No.: US 2015/0012505 A1
(43) Pub. Date: Jan. 8, 2015

(54) CONFIGURABLE DATA MASKS SUPPORTING OPTIMAL DATA EXTRACTION AND DATA COMPACTION

(71) Applicant: HONEYWELL INTERNATIONAL INC., Morristown, NJ (US)

(72) Inventors: Jeff vanderZweep, Peoria, AZ (US); Douglas L. Bishop, Phoenix, AZ (US); Petr Havlik, Brno (CZ); Vishnu Preethi Gangarapu, Hyderabad (IN); Raghupathy Kolandavelu, Salem (IN); Petr Dolak, Brno (CZ)

(21) Appl. No.: 13/933,181

(22) Filed: Jul. 2, 2013

(51) Int. Cl. G06F 17/30

(52) U.S. Cl. CPC G06F 17/30289
USPC 707/693

(57) ABSTRACT

Systems and methods are provided for accessing and storing variables the systems comprise a standardized executable application module (SEAM), a computer readable storage device containing the configuration data including a data matrix recorded thereon, the computer readable storage medium comprising a dynamic data store (DDS) and a static data store (SDS), wherein the DDS includes a temporary storage location expansion to the data matrix recorded in the SDS. The systems further comprise a workflow service module, the work flow service module including an encode utility and a decode utility, the workflow service module being configured to direct communication between the SDS, the DDS and the SEAM including retrieving a variable from, and storing the variable to, the computer readable storage device based on the encode utility, the decode utility and the data matrix stored in the SDS and in the DDS expansion.

### TECHNICAL FIELD

The present invention generally relates to architectures for condition-based maintenance systems, and more particularly relates to methods for using standardized executable application modules in conjunction with data masks for efficient data storage and extraction from multiple storage locations.

### BACKGROUND

Increases in vehicle complexity and the accompanying increase in maintenance costs have led to industry wide investments into the area of condition based maintenance (CBM). These efforts have led to the development of industry or equipment specific process solutions. However, conventional CBM systems are rigidly configured, which can result in cumbersome performance or require users to pay significant modification costs for customized performance.

FIG. 1 is a simplified block diagram of an exemplary multi-level maintenance process 10 that may be useful in monitoring a complex system (not shown). A complex system as discussed herein may be any type of vehicle, aircraft, manufacturing process, or machine that may utilize sensors, transducers or other data sources to monitor the various components and parameters of the complex system. The sensors/transducers are typically situated at the component or the process measurement level 20 to measure, collect and communicate raw data through a variety of data driven input/output (I/O) devices. This raw data may represent fault indicators, parametric values, process status and events, consumable usage and status, interactive data and the like. Non-limiting examples of other data sources may include serial data files, video data files, audio data files and built in test equipment.

Once the parameters of the complex system are measured, the measurement data is typically forwarded to more sophisticated devices and systems at an extraction level 30 of processing. At the extraction level 30, higher level data analysis and recording may occur such as the determination or derivation of trend and other symptom indicia.

Symptom indicia are further processed and communicated to an interpretation level 40 where an appropriately programmed computing device may diagnose, prognosticate default indications or track consumable usage and consumption. Raw material and other usage data may also be determined and tracked.

Data synthesized at the interpretation level 40 may then be compiled and organized by maintenance planning, analysis and coordination software applications at an action level 50 for reporting and other interactions with a variety of users at an interaction level 60.

Although processes required to implement a CBM system are becoming more versatile, the level of complexity of a CBM system remains high and the cost of developing these solutions is commensurately high. Attempts to produce an inexpensive common CBM solution that is independent from the design of the complex system that is being monitored have been less than satisfying. This is so because the combination and permutations of the ways in which a complex system can fail and the symptoms by which the failures are manifested are highly dependent on the system design.

Accordingly, it is desirable to develop a maintenance system architecture that is sufficiently flexible to support a range of complex systems. In addition, it is desirable to develop a maintenance system that may be easily reconfigured by a user in real time, thus dispensing with prohibitive reprogramming costs and delays. Furthermore, other desirable features and characteristics of the present invention will become apparent from the subsequent detailed description of the invention and the appended claims, taken in conjunction with the accompanying drawings and this background of the invention.

### BRIEF SUMMARY

A system is provided for accessing and storing variables. The system comprises a standardized executable application module (SEAM), which is a basic un-modifiable modular software object that is directed to complete a specific task after retrieving configuration data and a computer readable storage device containing the configuration data including a data matrix recorded thereon, the computer readable storage medium comprising a dynamic data store (DDS) and a static data store (SDS), wherein the DDS includes a temporary storage location expansion to the data matrix recorded in the SDS. The system further comprises a workflow service module, the work flow service module including an encode utility and a decode utility, the workflow service module being configured to direct communication between the SDS, the DDS and the SEAM including retrieving a variable from, and storing the variable to, the computer readable storage device based on the encode utility, the decode utility and the data matrix stored in the SDS and in the DDS expansion.

A method for accessing a desired variable from a plurality of locations in a message is provided. The method comprises receiving a data word by a SEAM, the SEAM being a basic un-modifiable modular software object that is directed to complete a specific task after retrieving configuration data, the data word being associated with a specific message type and a specific message ID, wherein the combined message type and the message ID is a unique input to a data matrix of a configuration file, the data matrix defining a data mask of a variable in the data word and reading the data mask from the data matrix associated with the variable from the data matrix on the computer readable storage device associated with the unique input. The method further comprises calling a decode utility, isolating the variable from the data word by applying the data mask to the data word by the decode utility, and inserting the value of the variable into a storage address in the DDS.

A method for storing a variable value to a storage locations is provided. The method comprises receiving a variable value embedded in a data word by a SEAM, the SEAM being a basic un-modifiable modular software object that is directed to complete a specific task after retrieving configuration data, the variable being associated with a specific message type and a specific message ID, wherein the combined message type and the message ID is a unique input to a data matrix of a configuration file stored on a computer readable storage device, the data matrix defining a storage address of the variable on the computer readable storage device and reading one data mask stored in the data matrix associated with the variable on the computer readable storage device associated with the unique input. The method further comprises calling a encode utility, positioning the variable in the data word by applying the data mask by the encode utility, and storing the data word into a storage address for the unique input.

### BRIEF DESCRIPTION OF THE DRAWINGS

The present invention will hereinafter be described in conjunction with the following drawing figures, wherein like numerals denote like elements, and

FIG. 1 is a simplified block diagram of a conventional multi-level maintenance process;

FIG. 2 is a simplified functional block diagram for embodiments of a hierarchical condition based maintenance system for monitoring a complex system;

FIG. 3 is a simplified schematic of an exemplary reconfigurable system to optimize run time performance of a hierarchical condition based maintenance system;

FIG. 4 is a simplified exemplary block diagram of an exemplary computing node illustrating it components;

FIG. 5 is an simplified block diagram of an exemplary lower level computing node SDS, DDS and workflow service with an exemplary event flow stream;

FIG. 6 is a simplified block diagram of an exemplary computing node SDS and its extension into an associated DDS;

FIG. 7 is an abstract relationship diagram between components stored in the SDS and associated extensions located in SDS extensions of the DDS;

FIG. 8 is simplified block diagrams of an exemplary lower level computing node SDS, DDS and workflow service with an exemplary event flow stream for augmenting the capabilities of the lower level computing node from the function augmentation data matrix;

FIG. 9 is a simplified logic flow diagram of an exemplary method for coordinating functions of a computing device to accomplish a task.

FIGS. 10A-B illustrates a method of isolating a variable from a message for storage;

FIGS. 11A-B illustrates a method of retrieving a variable for inclusion in a message;

FIGS. 12A-B illustrates an exemplary method using data masks to retrieve variable data for a response in a message.

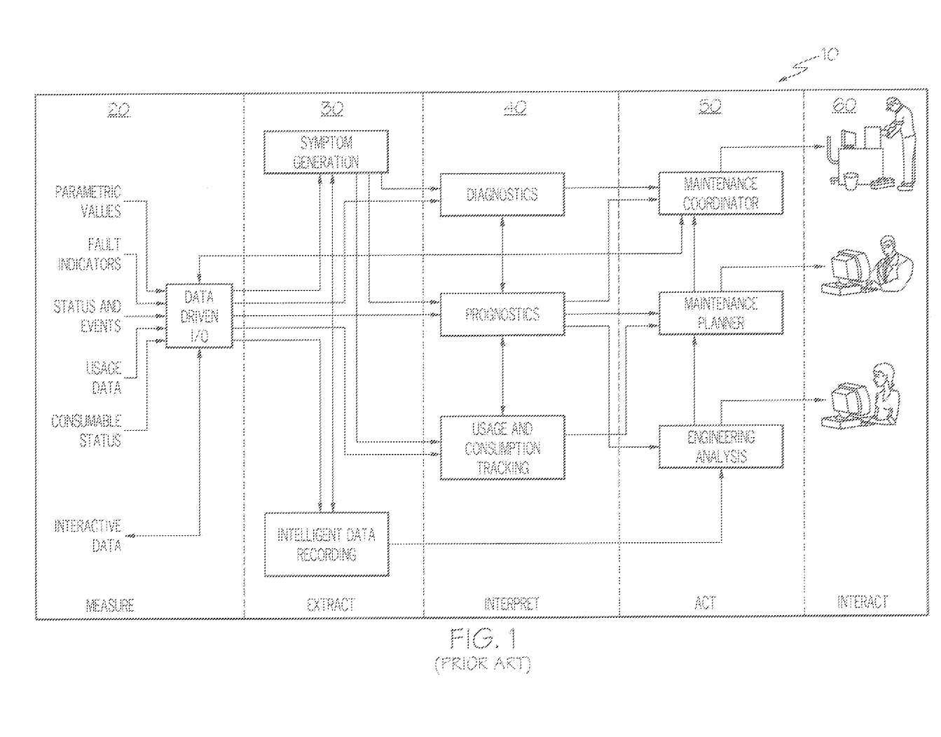

### DETAILED DESCRIPTION

The following detailed description is merely exemplary in nature and is not intended to limit the invention or the application and uses of the invention. As used herein, the term “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Those of skill in the art will appreciate that the various illustrative logical blocks, modules, circuits, and algorithm steps described in connection with the embodiments disclosed herein may be implemented as electronic hardware, software executable by a computing device, or combinations of both. Some of the embodiments and implementations are described below in terms of functional and/or logical block components (or modules) and various processing steps. However, it should be appreciated that such block components (or modules) may be realized by any number of hardware and/or firmware components configured to perform the specified functions. To clearly illustrate this interchangeability of hardware and software, various illustrative components, blocks, modules, circuits, and steps are described herein generally in terms of their functionality. However, it should be understood that software cannot exist without hardware with which to execute the software. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a controller, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The term “exemplary” is used exclusively herein to mean “serving as an example, instance, or illustration.” Any embodiment described herein as “exemplary” is not necessarily to be construed as preferred or advantageous over other embodiments.

The steps of a method or algorithm described in connection with the embodiments disclosed herein may be embodied directly in hardware, in a software module with instructions executed by a processor, or in a combination of the two. A software module may reside in RAM memory, flash memory, ROM memory, EPROM memory, EEPROM memory, registers, hard disk, a removable disk, a CD-ROM, or any other form of computer readable storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, terms such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment will be presented in the following detailed description, it should be appreciated that a vast number of variations exist. It should also be appreciated that the exemplary embodiment or exemplary embodiments are only examples, and are not intended to limit the scope, applicability, or configuration of the invention in any way. Rather, the following detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

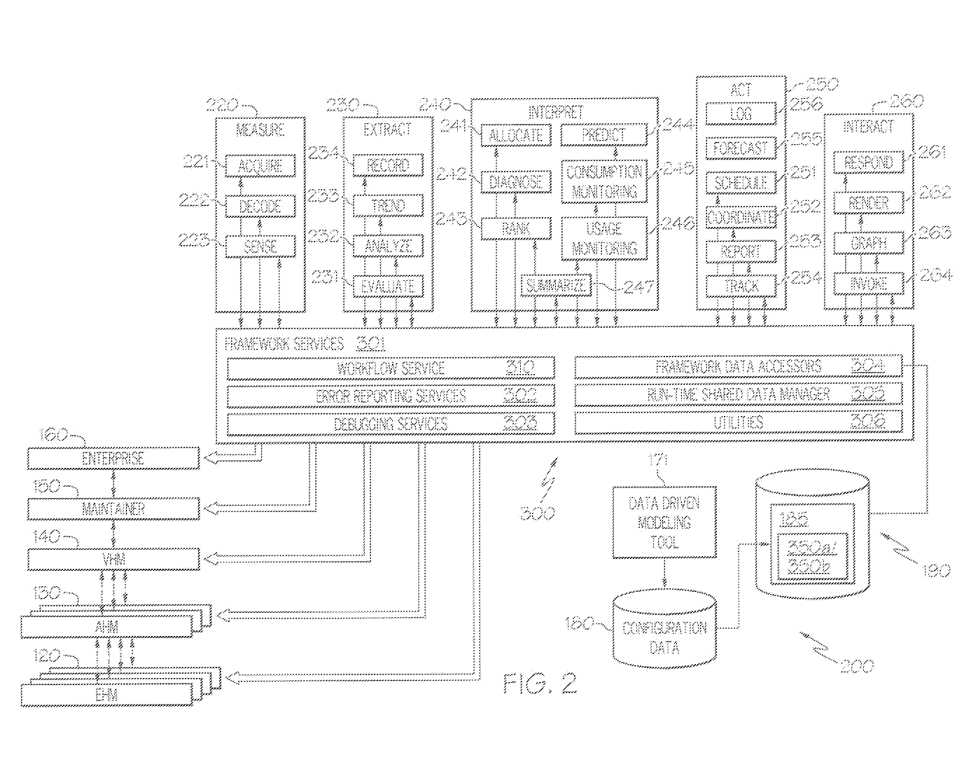

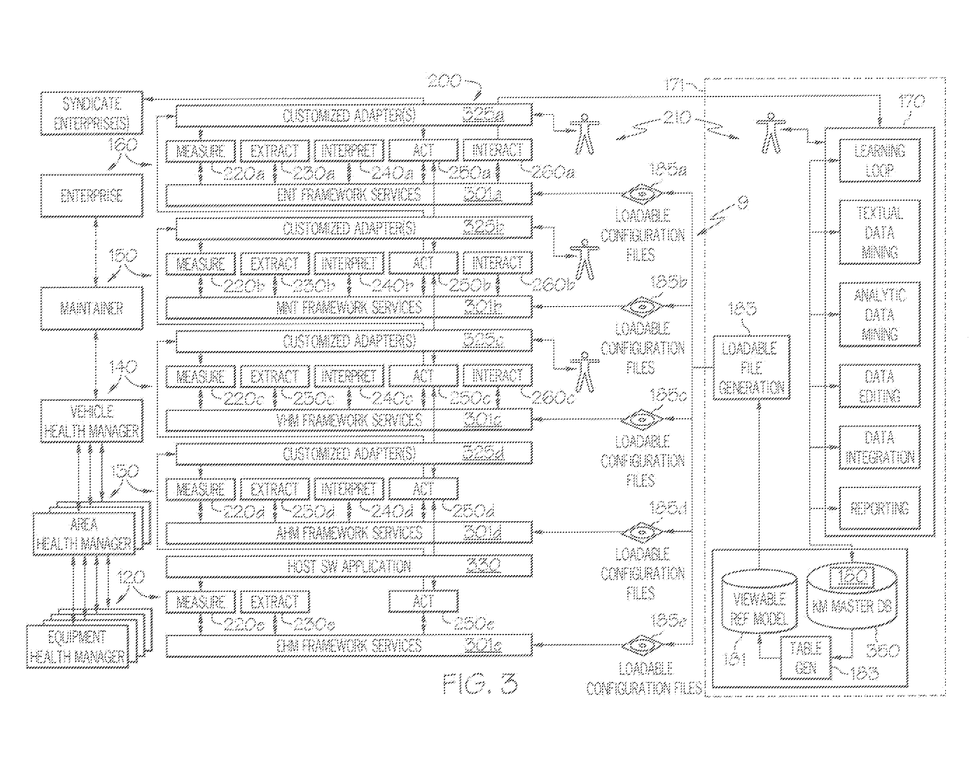

FIG. 2 is a simplified functional block diagram for embodiments of a hierarchical structure 200 that may be timely reconfigured by a user. This may be accomplished by altering a set of configuration data 180 via a data driven modeling tool 171, which also may be described as a model based configuration means. The configuration data 180 may be stored in a static data store (e.g. an EEPROM), a dynamic data store (e.g. RAM), or both 190.

In light of the plethora of complex systems that may be monitored by the embodiments being described herein below and the wide range of functionality that may be desired at any point in the complex system, the following description contains non-limiting examples of the subject matter being disclosed herein. A specific non-limiting example of a complex system that may complement the following exemplary embodiments may be the vehicle as described in co-owned, co-pending application Ser. No. 12/493,750, which is assigned to the assignee of the instant application.

For the sake of brevity and simplicity, the present example will be assumed to have only five different processing levels or “application layers.” An Application Layer (120-160) is a set of functions or services programmed into run-time software resident in one or more computing nodes sharing a particular hierarchical level and which is adapted to meet the needs of a user concerning a particular management implementation. As non-limiting examples, an application layer may be an Equipment Health Manager (EHM) Layer 120, an Area Health Manager (AHM) Layer 130, a Vehicle Heath Manager (VHM) Layer 140, a Maintainer Layer 150, or an Enterprise Layer 160.

However, in equivalent embodiments discussed herein, the hierarchical structure 200 may have any number of levels of application layers (120-160). Application layers (120-160) may include any number of computing nodes, which are computing devices. The number of nodes is determined by the complexity of the complex system and the sophistication of the monitoring desired by the user. In some embodiments, multiple nodes (120′-160′) may be resident in one computing device. The computing nodes of the equipment based layers (EHM Layer 120, AHM Layer 130, VHM Layer 140, Maintainer layer 150 and Enterprise layer 160) may be also referred to as an EHM node 120′, an AHM node 130′, a VHM node 140′, a maintainer node 150′ and an enterprise node 160′.

In the exemplary embodiments disclosed herein, an EHM node 120′ is a computing device that provides an integrated view of the status of a single component of the monitored assets comprising the lowest level of the hierarchical structure 200. The EHM node 120′ may have different nomenclature favored by others. For example, in equivalent embodiments the EHM node 120′ also be known as a Component Area Manager (CAM). A complex system may require a large number of EHM nodes (120′), each of which may include multiple times series generation sources such as sensors, transducers, Built-In-Test-Equipment (BITE) and the like. EHM nodes (120′) are preferably located in electronic proximity to a time series data generation source in order to detect symptomatic times series patterns when they occur.

An AHM node 130′ is a computing device situated in the next higher hierarchical level of the hierarchical structure 200 and may receive and process message, command and data inputs received from a number of EHM nodes 120′ and other nodes 130′-160′. An AHM node 130′ may report and receive commands and data from higher level or lower level components of the hierarchical structure 200. An AHM node 130′ processes data and provides an integrated view of the health of a single sub-system of the complex system being monitored. The AHM node 130′ may have different nomenclature favored by others. For example, in equivalent embodiments the AHM node 130′ also be known as a Sub-system Area Manager (SAM).

A VHM node 140′ is a computing device situated in the next higher hierarchical level for the hierarchical structure 200 and may receive and process message, command and data inputs received from a number of EHM nodes 120′ and AHM nodes 130′. A VHM node 140′ may report and receive commands and data from higher level components of the hierarchical structure 200 as well. A VHM node 140′ processes data and provides an integrated view of the health of the entire complex system being monitored. The VHM node 140′ may have different nomenclature favored by others. For example, in equivalent embodiments the VHM node 140′ also be known as a system level control manager (SLCM).

A Maintainer Layer 150 contains one or more maintainer computing nodes (150′) that analyze data received from the EHM nodes (120′), AHM nodes 130′ and VHM nodes node 140′ and supports local field maintenance activities. Non-limiting examples of an Maintainer Level computing system is the Windows® PC ground based station (PC-GBS) software produced by Intelligent Automation Corporation a subsidiary of Honeywell International of Morristown, N.J.; or the US Army's Platform Soldier-Mission Readiness System (PS-MRS). The Maintainer Layer system may have different nomenclature favored by others. MNT nodes 150′ also receive data, commands and messages from higher level nodes 160′.

A maintainer node 150′ may be permanently or removably inserted at a particular electronic and/or physical location within the hierarchical structure 200. A maintainer node 150′ may also be any suitable portable computing device or a stationary computing device that may be connected physically or electronically at any particular node (120′-160′) or other point of access with in the hierarchical system 200. Thus, a maintenance technician is not bound to a particular location in the hierarchical system from which to monitor the complex system.

An Enterprise Layer 160 contains one or more computing nodes (160′) that analyze data received from the EHM nodes 120′, AHM nodes 130′, VHM nodes 140′ and the Maintainer Layer 150. The Enterprise level supports the maintenance, logistics and operation of a multitude or fleet of assets. Non-limiting examples of an Enterprise Layer 160 computing system is the ZING™ system and the Predictive Trend Monitoring and Diagnostics System from Honeywell International. The Enterprise layer 160 may have different nomenclature favored by others.

In accordance with the precepts of the subject matter disclosed herein, each computing node (120′-160′) of each level of the hierarchical structure 200 may be individually and timely configured or reconfigured by the user by way of the data driven modeling tool 171. The data driven modeling tool 171 allows a user to directly alter the configuration data 180, which in turn provides specific direction and data to, and/or initiates, one or more standardized executable application modules (SEAMs) (221-264) resident in each computing node (120′-160′) of the hierarchical structure 200 via the model driven GUI 170. This initiation is done without the need for recompiling or linking/relinking SEAMS in populating a particular node. In the following description the term “configure” and “provide specific direction and data” may be used synonymously.

The number of SEAMs (221-264) is not limited and may be expanded beyond the number discussed herein. Similarly, the SEAMs (221-264) discussed herein may be combined into fewer modules or broken down into component modules as may be required without departing from the scope of the disclosure herein. The SEAMs (221-264) are a set of run-time software that are selectable from one or more re-use libraries (220-260) and are subsequently directed to meet the maintenance implementation needs of a user. Each SEAM (221-264) contains executable code comprising a set of logic steps defining standardized subroutines designed to carry out a basic function that may be directed and redirected at a later time to carry out a specific functionality.

There are 24 exemplary SEAMs (221-264) discussed herein that are selected from five non-limiting, exemplary libraries: a Measure Library 220, an Extract Library 230, an Interpret Library 240, an Act Library 250 and an Interact Library 260. The SEAMs (221-264) are basic un-modifiable modular software objects that are directed to complete specific tasks via the configuration data 180 after the SEAMs (221-264) are populated within the various nodes (120′-160′) of the hierarchical structure 200. The configuration data 180 is implemented in conjunction with a SEAM (221-264) via the delivery to a node (120′-160′) of a configuration file 185 containing the configuration data 180. Once configured, the SEAMs (221-264) within the node may then cooperatively perform a specific set of functions on data collected from the complex system without being compiled or linked/relinked together. A non-limiting example of a specific set of functions may be a health monitoring algorithm.

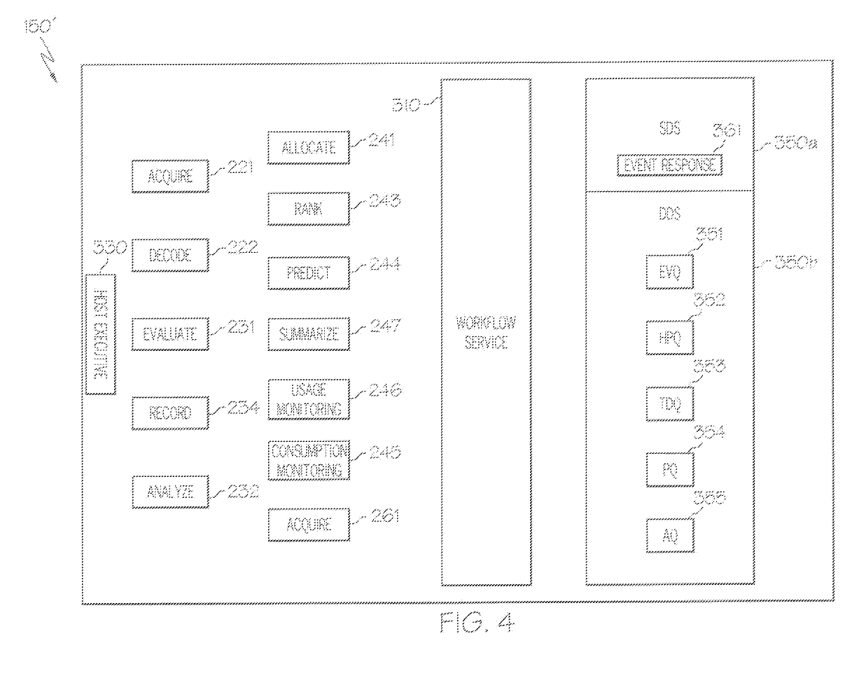

As non-limiting examples, the Measure Library 220 may include an Acquire SEAM 221, a Sense SEAM 223, and a Decode SEAM 222. The Acquire SEAM 221 functionality may provide a primary path for the input of data into a computing node (120′-160′) through a customized adapter 325 (See, FIG. 3) which embodies external callable interfaces. The customized adapter 325 pushes blocks of data into an Acquire SEAM 221, which then parses the data block and queues it for subsequent processing by another executable application (222-264).

The Sense SEAM 223 may provide a secondary path for the input of data into a computing node (120′-160′) through a system initiated request to read data from a physical I/O device (i.e. Serial data ports, Sensor I/O interfaces, etc.). The Sense SEAM 223, then parses the data block, and queues it for subsequent processing by another executable application (222-264).

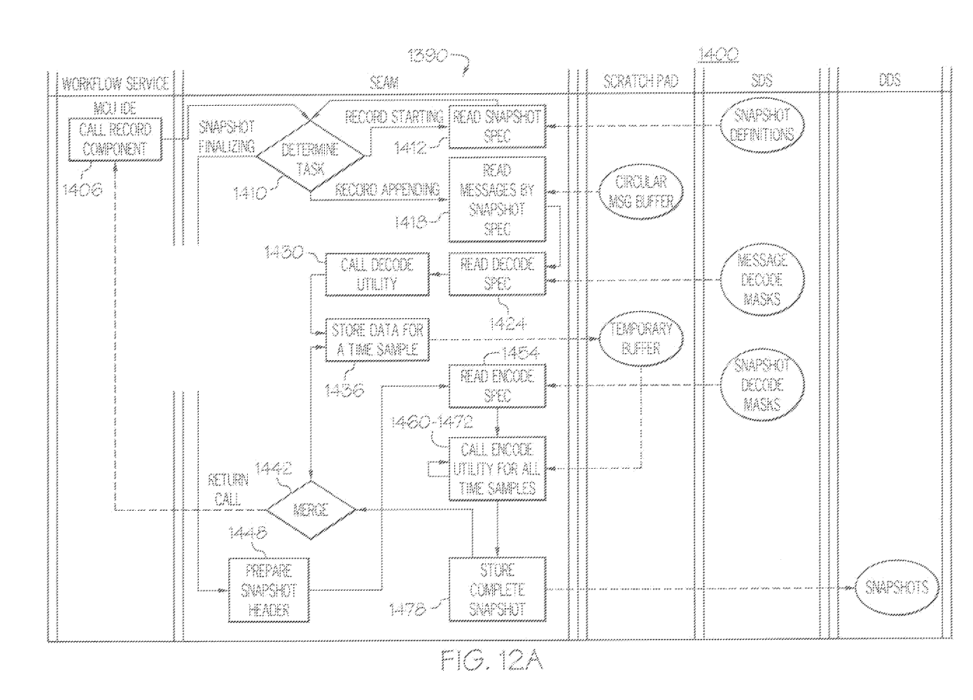

The Decode SEAM 222 may take the data queued by the Acquire SEAM 221 or Sense SEAM 223 and translate the data into a useable form (i.e. symptoms and/or variables) that other executable applications can process. The Decode SEAM 222 may also fill a circular buffer 380 (See, FIGS. 11a-c) with the data blocks queued by an Acquire SEAM 221 to enable snapshot or data logging functions.

The Extract Library 230 may include an Evaluate SEAM 231, a Record SEAM 234, an Analyze SEAM 232, a Trend SEAM 233 and a record SEAM 234. The Evaluate SEAM 231 may perform a periodic assessment of state variables of the complex system to trigger data collection, set inhibit conditions and detect complex system events based on real-time or near real-time data.

The Record SEAM 234 may evaluate decoded symptoms and variables to determine when snapshot/data logger functions are to be executed. If a snapshot/data log function has been triggered, the Record SEAM 234 may create specific snapshot/data logs and send them to a dynamic data store (DDS) 350b. The DDS 350b is a data storage location in a configuration file 185. Snapshots may be triggered by another executable application (221-264) or by an external system (not shown).

The Analyze SEAM 232 may run one or more algorithms using the variable values and trend data that may have been assembled by the Trend SEAM 233 and subsequently stored in a dynamic data store (DDS) 350b to determine specific symptom states and/or provide estimates of unmeasured parameter values of interest.

The Interpret Library 240 may include an Allocate SEAM 241, a Diagnose SEAM 242, a Rank Seam 243, a Predict SEAM 244, A Consumption Monitoring SEAM 245, a Usage Monitoring SEAM 246, and a Summarize SEAM 247. The Allocate SEAM 241 may perform inhibit processing, cascade effect removal and time delay processing on a set of symptoms, and then allocate the symptoms to the appropriate fault condition(s) that is (are) specified for the monitored device or subsystem. The Allocate SEAM 241 may also update the state of each fault condition based on changes in the state of any particular symptom associated with a fault condition.

The Diagnose SEAM 242 may orchestrate interaction between a system user, monitored assets and diagnostic reasoning to reduce the number of ambiguous failure modes for a given active fault condition until a maintenance procedure is identified that will resolve the root cause of the fault condition.

The Rank SEAM 243 may rank order potential failure modes after diagnostic reasoning has been completed. The failure modes, related corrective actions (CA) and relevant test procedures associated with a particular active fault condition are ranked according to pre-defined criteria stored in a Static Data Store (SDS) 350a. A SDS is a static data storage location in a configuration file 185 containing a persistent software object that relates an event to a pre-defined response.

The Predict SEAM 244 may run prognostic algorithms on trending data stored in the DDS 350b in order to determine potential future failures that may occur and provide a predictive time estimate. The Predict SEAM may also be known as an FC State Evaluation SEAM.

The Consumption Monitoring SEAM 245 may monitor consumption indicators and/or may run prognostic algorithms on trending data stored in the DDS 350b that are configured to track the consumption of perishable/life-limited supply material in the complex system and then predict when resupply will be needed. The consumption monitoring functionality may be invoked by a workflow service module 310, which is a component functionality of an internal callable interface 300 and will be discussed further below.

The Usage Monitoring SEAM 246 may monitor trend data stored in the DDS 350b to track the usage of a monitored device or subsystem in order to estimate the need for preventative maintenance and other maintenance operations. The usage monitoring functionality may be invoked by the workflow service module 310, which is a component 261 functionality of the internal callable interface 300.

The Summarize SEAM 247 may fuse maintenance data received from all subsystems monitored by an application layer and its subordinate layers (120-160) into a hierarchical set of asset status reports. Such reports may indicate physical or functional availability for use. The asset status reports may be displayed in a series of graphics or data trees on the GUI 170 that summarizes the hierarchical nature of the data in a manner that allows the user to drill down into the CBM layer by layer for more detail. The Summarize functionality may be invoked by the Workflow service module 310. This invocation may be triggered in response to an event that indicates that a diagnostic conclusion has been updated by another module of the plurality. The display of the asset status may be invoked by the user through the user interface.

The Act Library 250 may include a Schedule SEAM 251, a Coordinate SEAM 252, a Report SEAM 253, a Track SEAM 254, a Forecast SEAM 255 and a Log SEAM 256. The Schedule SEAM 251 schedules the optimal time in which required or recommended maintenance actions (MA) should be performed in accordance with predefined criteria. Data used to evaluate the timing include specified priorities and the availability of required assets such as maintenance personnel, parts, tools, specialized maintenance equipment and the device/subsystem itself. Schedule functionality may be invoked by the workflow service module 310.

The Coordinate SEAM 252 coordinates the execution of actions and the reporting of the results of those actions between application layers (120-160) and between layers and their monitored devices/subsystems. Exemplary, non-limiting actions include initiating a BIT or a snapshot function. Actions may be pushed into and results may be pulled out of the Coordinate SEAM 252 using a customized adapter 325a-e which embodies an external callable interface. The customized adapter 325a-e may be symmetric such that the same communications protocol may be used when communicating up the hierarchy as when communicating down the hierarchy.

The Report SEAM 253 may generate a specified data block to be sent to the next higher application in the hierarchy and/or to an external user. Report data may be pulled from the Report SEAM 253 by the customized adapter 325a-e. The Report SEAM 253 may generate data that includes a health status summary of the monitored asset.

The Track SEAM 254 may interact with the user to display actions for which the user is assigned and to allow work to be accomplished or reassigned.

The Forecast SEAM 255 may determine the need for materials, labor, facilities and other resources in order to support the optimization of logistic services. Forecast functionality may be invoked by the Workflow service module 310.

The Log SEAM 256 may maintain journals of selected data items and how the data items had been determined over a selected time period. Logging may be performed for any desired data item. Non-limiting examples include maintenance actions, reported faults, events and the like.

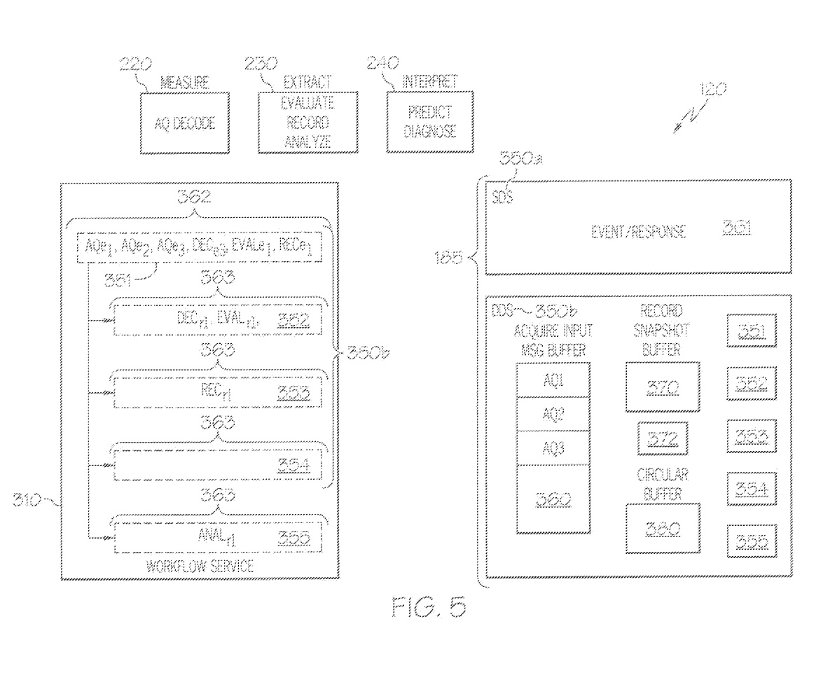

The Interact Library 260 may include a Render SEAM 262, a Respond SEAM 261, a Graph SEAM 263, and an Invoke SEAM 264. The Render SEAM 262 may construct reports, tabularized data, structured data and HTML pages for display, export or delivery to the user via a user interface 461 (See, FIG. 4).

The Respond SEAM 261 may render data for display to the user describing the overall health of the complex system and to support detailed views to allow “drill down” for display of summary evidence, recommended actions and dialogs. The rendering of display data may be initiated by the Workflow service module 310; but the data may be pulled from the Render SEAM 262 via the callable interface 300. The Respond SEAM 261 may also receive and process commands from the user then route the commands to the appropriate module in the appropriate node for execution and processing. The commands may be pushed into the Respond Module via the callable interface 300.

The Graph SEAM 263 may provide graphical data for use by the Render SEAM 262 in the user displays on GUI 170. The graphical data may include the static content of snapshot and trend files or may dynamically update the content of the data in the circular buffer.

The Invoke SEAM 264 may retrieve documents to be displayed to a user interface 461 via a maintainer node 150′ or interacts with an external document server system (not shown) to cause externally managed documents to be imported and displayed.

To reiterate, each of the SEAMs (221-264) discussed above are never modified. The SEAMs (221-264) are loaded into any computing node (120′-160′) of the hierarchical structure 200 and any number of SEAMs may be loaded into a single node. Once installed, each standard executable application module (221-264) may be initialized, directed and redirected by a user by changing the configuration data 180 resident in the database 190 to perform specific tasks in regard to its host computing device or platform. Methods for such redirection are further described in co-owned, co-pending application Ser. Nos. 13/016,601, 13/477,735, 13/273,984, 13/115,690, 13/572,518, 13/630,906 and in issued U.S. Pat. No. 8,468,601 each of which are incorporated herein by reference in their entirety.

Communication between SEAMs (221-264) within a node is facilitated by a callable interface 300. A callable interface 300 is resident in each computing node (120′-160′) of the hierarchical structure 200. The callable interface 300 may have several sub-modules (302-310) that may be co-resident in a single computing device of a computing node (120′-160′). Exemplary sub-modules of the callable interface 300 may include a framework executive 301 as a component of the callable interface 300, a workflow service module 310, an error reporting server 302, a debugging server 303, a framework data accessor, a run-time shared data manager 305 and utilities 306. Those of ordinary skill in the art will recognize that in equivalent embodiments a “module,” “a sub-module,” “a server,” or “a service” may comprise software executing on a hardware device, hardware, firmware or a combination thereof.

The framework executive 301 of a computing node provides functions that integrate the nodes within the hierarchical structure 200. The framework executive 301 in conjunction with the configuration files 185 coordinate initialization of each node including the SEAMs (221-264) and the other service modules (301-310) allowing the execution of functions that are not triggered by a customized adapter 325 (discussed further below). In some embodiments, the computing nodes in all application layers may have a framework executive 301. In other embodiments, nodes in most application layers except, for example, an EHM Layer 120 will have a framework executive 301. In such embodiments, the computing nodes 120′ in the EHM layer 120 may rely on its host platform (i.e. computing device) operating software to perform the functions of the framework executive.

Error reporting services 302 provide functions for reporting run-time errors in a node (120′-160′) within the hierarchical structure 200. The error reporting server 302 converts application errors into symptoms that are then processed as any other failure symptom, reports application errors to a debugging server 303 and reports application errors to a persistent data manager (not shown).

Debugging services 303 collects and reports debugging status of an executable application module (221-264) during testing, integration, certification, or advanced maintenance services. This server may allow the user to set values for variables in the DDS 350b and to assert workflow events.

The framework data accessor 304 provides read access to the SDS 350a and read/write access to the DDS 350b (each stored in a memory 190) by the SEAMs (221-264) in a computing node (120′-160′). Write access to the SDS 350a is accomplished via the data modeling tool 171, which includes GUI 170.

The run-time shared data manager 305 manages all node in-memory run-time perishable data structures that are shared between SEAMs (221-264) that are not stored in the DDS 350b, but does not include cached static data. As non-limiting examples of perishable data structures may include I/O queues and circular buffers.

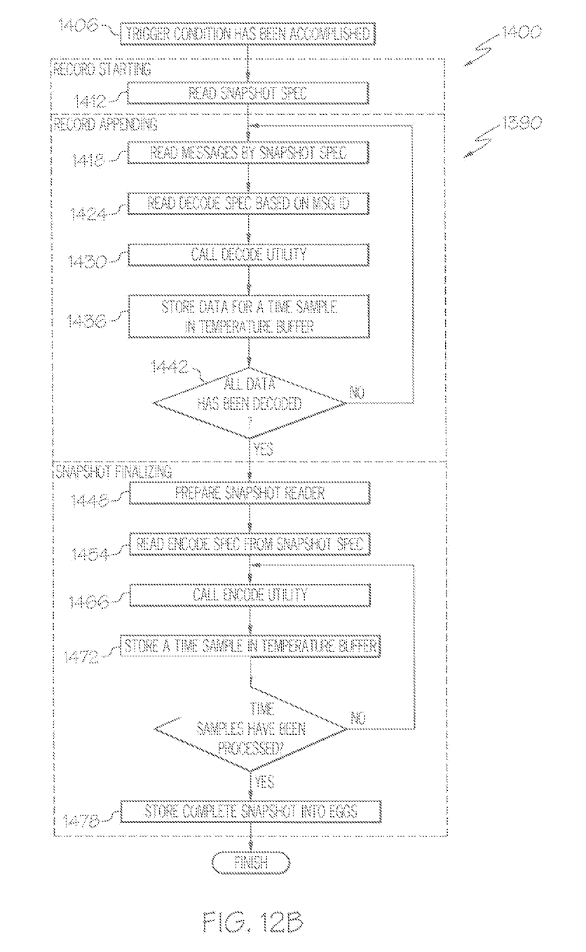

Utilities 306 may include common message encoding/decoding, time-stamping and expression evaluation functions for use by the SEAMs (221-264) installed in a computing node. Encoding and decoding utilities are each different and unique utilities. Among other things the decode utility uses a data mask to isolate a variable from a message or other data structure. Among other things the encode utility uses a data mask to insert or position a variable from a storage location into a message or other data structure. See, FIGS. 12A and 12B for exemplary methods using encode and decode utilities in the context of an exemplary data snapshot request.

The work flow service module 310 is a standard set of logic instructions that enable a data-driven flow of tasks within a computing node to be executed by the various SEAMs (221-264) within the node. The workflow service module 310 acts as a communication control point within the computing node where all communications related to program execution to or from one executable application module (221-264) are directed through the node's workflow service module 310. Stated differently, the workflow service module 310 of a node (120′-160′) orchestrates the work flow sequence among the various SEAMs (221-264) that happen to reside in the node. In some embodiments the workflow service module 310 may be a state machine. Exemplary workflow service operations are described in detail in co-owned, co-pending application Ser. Nos. 13/918,584, 13/016,601, 13/477,735, 13/273,984, 13/115,690, 13/572,518, 13/630,906 and in issued U.S. Pat. No. 8,468,601 each of which are incorporated herein by reference in their entirety.

FIG. 3 is a simplified, exemplary schematic of a configured hierarchical structure 200 that may optimize the run time performance of the hierarchical structure 200. The exemplary embodiment of FIG. 3 features a hierarchical structure 200 comprising five exemplary hierarchical layers (120-160), although in other embodiments the number of hierarchical layers may range from a single layer to any number of layers. Each hierarchical layer (120-160) includes one or more nodes (120′-160′) containing SEAMs (221-264) that were copied and loaded from one of the reusable libraries (220-260) into a computing node (120′-160′) in the layer. Each SEAM (221-264) may be configured by a user 210 by modifying its respective loadable configuration file 185. The loadable configuration file 185 is constructed using the data driven modeling tool 171.

For the sake of simplicity, the SEAMs (221-264) may be discussed below in terms of their respective libraries. The number of combinations and permutations of executable applications (221-264) is large and renders a discussion using specific SEAMs unnecessarily cumbersome.

At an EHM layer 120, there may be a number of EHM nodes 120′, each being operated by a particular host computing device that is coupled to one or more sensors and/or actuators (not shown) of a particular component of the complex system. As a non-limiting example, the component of the complex system may be a roller bearing that is monitored by a temperature sensor, a vibration sensor, a built-in-test, sensor and a tachometer, each sensor being communicatively coupled to the computing device (i.e. a node). As a non-limiting example, the host computing device of an EHM node 120′ of the complex system may be a computer driven component area manager (“CAM”) (i.e. a node). For a non-limiting example of a CAM that may be suitable for use as EHM nodes, see co-owned, co-pending U.S. patent application Ser. No. 12/493,750.

Each host EHM computing device 120′ in this example is operated by a host software application 330. The host executive software 330 may be a proprietary program, a custom designed program or an off-the-shelf program. In addition to operating the host device, the host software application also may support any and all of the SEAMs (221-264) via the framework services 301 by acting as a communication interface means between EHM nodes 120′ and between EHM nodes 120′ and other nodes located in the higher levels.

The exemplary embodiment of FIG. 3 illustrates that the host executive software 330 of an EHM node 120′ may host (i.e. cooperate) one or more SEAMs 220e from the Measure Library 220, one or more SEAMs 230e from the Extract Library 230 and one or more SEAMs 250e from the Act Library 250. The SEAMs 220e, 230e, and 250e are identical to their counterpart application modules that may reside in any another node in any other level in the hierarchical structure 200. Only when directed by the configuration file 185e, will a SEAM(s) (221-264) differ in performance from its counterpart module that has been configured for and is a resident in another node in the hierarchical structure 200. Once configured/directed, a standardized executable application (221-264) becomes a special purpose executable application module.

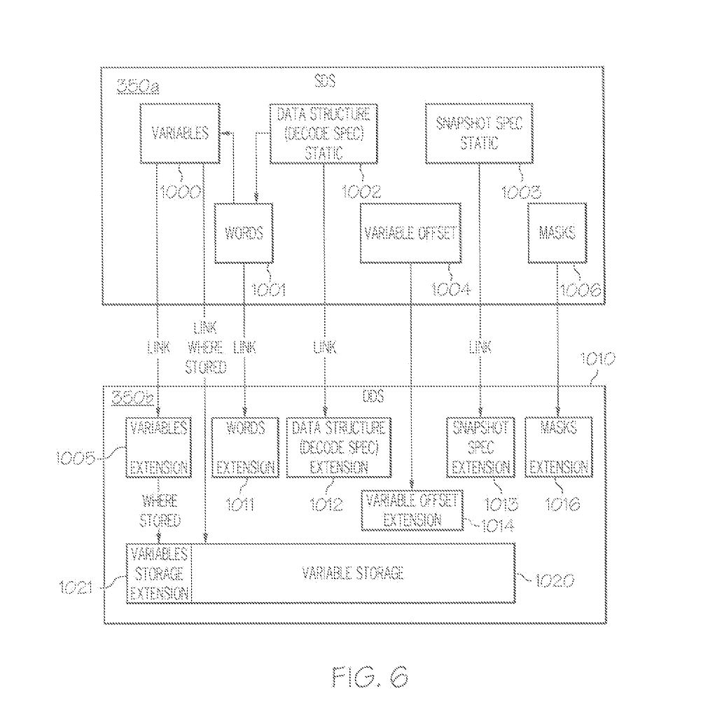

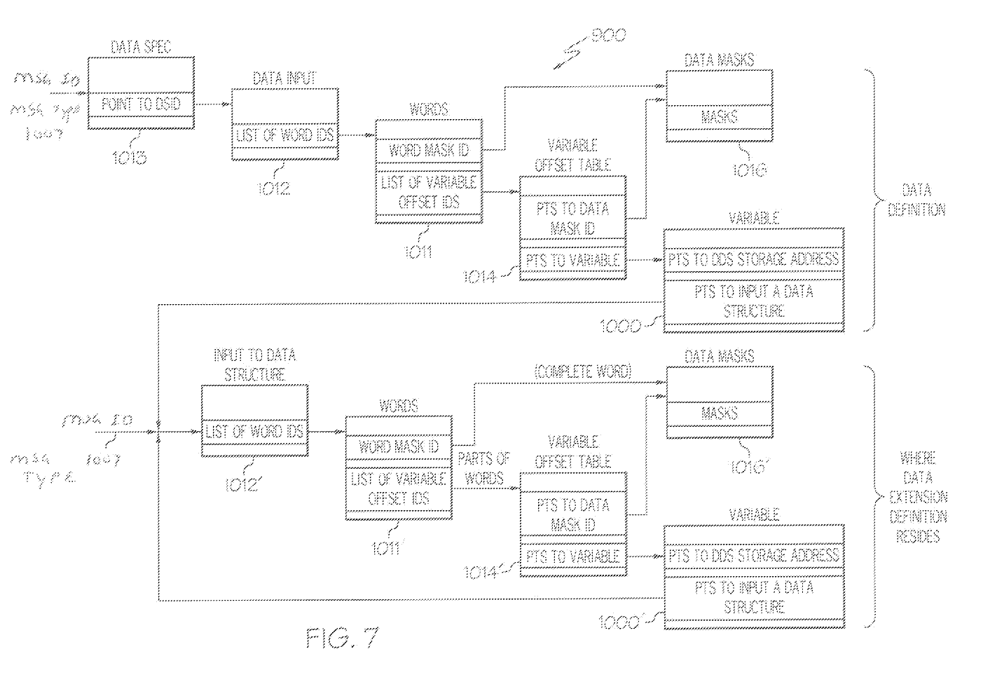

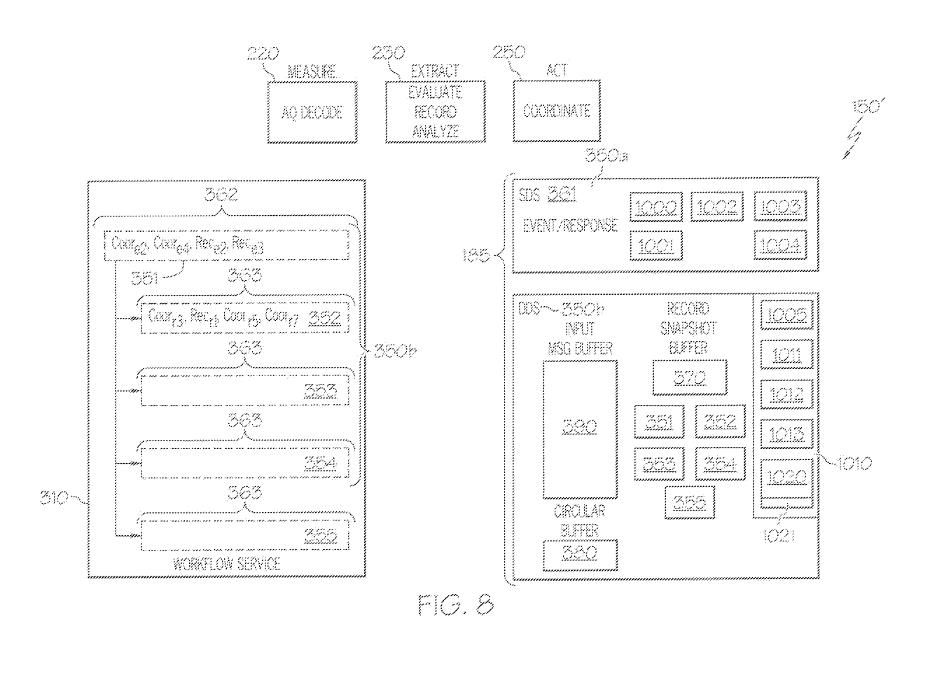

At an AHM layer 130, there may be a number of AHM nodes 130′. Each AHM node is associated with a particular host computing device that may be coupled to one or more sensors and/or actuators of a particular component(s) or a subsystem of the complex system and are in operable communication with other AHM nodes 130′, with various EHM nodes 120′ and with higher level nodes (e.g., see 501, 502, 601 and 602 in FIGS. 5-6). As a non-limiting example, the host computing device of an AHM of the complex system may be a computer driven sub-system area manager (“SAM”) (i.e. a node) operating under its own operating system (not shown). For non-limiting examples of a SAM that may be suitable for use as an AHM node, see co-owned U.S. Pat. No. 8,442,690.

The exemplary AHM node 130′ of FIG. 3 illustrates that the AHM node 130′ has an additional interpret functionality 240d that in this example has not been configured into the EHM node 120′. This is not to say that the EHM node 120′ cannot accept or execute a function from the Interpret library 240, but that the system user 210 has chosen not to populate the EHM node 120′ with that general functionality. On the other hand, the AHM node 130′ software hosts one or more SEAMs 220d from the Measure Library 220, one or more SEAMs 230d from the Extract Library 230 and one or more SEAMs 250d from the Act Library 250. In their unconfigured or undirected state, the SEAMs 220d, 230d, and 250d are identical to their counterpart application modules that may reside in any another node in any other level in the hierarchical structure 200.

Unlike the exemplary EHM node 120′, the exemplary AHM node 130′ may include a different communication interface means such as the customized adapter 325d. A customized adapter 325 is a set of services, run-time software, hardware and software tools that are not associated with any of the SEAMs (221-264). The customized adapters 325 are configured to bridge any communication or implementation gap between the hierarchical CBM system software and the computing device operating software, such as the host application software 410 (See, FIG. 4). Each computing node (120′-160′) may be operated by its own operating system, which is its host application software. For the sake of clarity, FIG. 3 shows only the host executive software 330 for the EHM node 120′. However, host application software exists in all computing nodes (120′-160′).

In particular the customized adapters 325 provide symmetric communication interfaces (e.g., communication protocols) between computing nodes and between computing nodes of different levels. The customized adapter 325 a-d allow for the use of a common communication protocol throughout the hierarchical structure 200 from the lowest EHM layer 120 to the highest enterprise layer 160 as well as with the memory 190.

At a VHM layer 140, there may be a number of VHM nodes 140′, each VHM node is associated with a particular host computing device that may be in operative communication with one or more sensors and/or actuators of a particular component(s) of the complex system via an EHM node 120′ or to subsystems of the complex system and that are in operable communication via their respective AHM nodes 130′. As a non-limiting example, the VHM node 140′ may be a computer driven system level control manager (“SLCM”) (i.e. also a node). For non-limiting examples of a SLCM that may be suitable for use as a VHM node, see co-owned U.S. Pat. No. 8,442,690.

In the exemplary hierarchical structure 200 there may be only one VHM node 140′, which may be associated with any number of AHM node 130′ and EHM node 120′ nodes monitoring a sub-systems of the complex system. In other embodiments, there may more than one VHM node 140′ resident within the complex system. As a non-limiting example, the complex system may be a fleet of trucks with one VHM node 140′ in each truck that communicates with several EHMs 120′ and with several AHM nodes 130′ in each truck. Each group of EHM nodes 120′ and AHM nodes 130′ in a truck may also be disposed in a hierarchical structure 200

FIG. 3 further illustrates that the exemplary VHM node 140′ has an additional Interact functionality 260c that has not been loaded into the EHM node 120′ or into the AHM node 130′. This is not to say that these lower level nodes cannot accept or execute an Interact function 260, but that the system user 210 has chosen not to populate the lower level nodes with that functionality. On the other hand, for example, the host software of VHM node 140′ hosts one or more SEAMs 220c from the Measure Library 220, one or more SEAMs 230c from the Extract Library 230, one or more SEAMs 240c from the Interpret Library 240 and one or more SEAMs 250c from the Act Library 250. The executable applications from the Interact library allow the system user 210 to access the VHM node 140′ directly and to view the direction thereof via the GUI 170. In their undirected state, the SEAMs 220c, 230c, 240c and 250c are identical to their counterpart application modules that may reside in any another node in any other level in the hierarchical structure 200. The standardized executable applications 220c-260c are directed to carry out specific functions via configuration files 185c.

Like the exemplary AHM node 130′, an exemplary VHM node 140′ includes a customized adapter 325c. The customized adapter 325c is also configured to bridge any communication or implementation gap between the hierarchical system software and the computing device operating software operating within VHM node 140′.

At the Maintainer (MNT) layer 150, there may be a number of MNT nodes 150′, each MNT node is associated with a particular host computing device that may be in operative communication with one or more sensors and/or actuators of a particular component(s) of the complex system via an EHM node 120′, in operative communication with one or more subsystems of the complex system and that are in operable communication via their respective AHM node 130′, and to the VHM nodes 140′. As a non-limiting example, the MNT node 150′ may be a laptop computer in wired or wireless communication with the communication system 9 of the hierarchical structure 200. Conversely, the MNT node 150′ may be a stand alone computing device in a fixed location within the hierarchical structure 200.

FIG. 3 illustrates that the exemplary MNT node 150′ may have the functionality of some or all of the executable applications (221-264). This is not to say that these lower level nodes cannot accept or execute any of the SEAMS (221-264), but that the system user 210 has chosen not to populate the lower level nodes with that functionality. Like the exemplary VHM node 140′ the SEAM 260b from the Interact library allow the system user 210 to access the Maintainer node 150′ directly and may view the direction thereof via the GUI 170. In their undirected state, the SEAMs 220b, 230b, 240b and 250b are identical to their standard counterpart application modules that may reside in any another node in any other level in the hierarchical structure 200. The SEAMs 220b-260b are directed to carry out specific functions via configuration files 185b. Reconfiguration is more fully described in co-owned, co-pending application Ser. Nos. 13/016,601, 13/918,584, 13/477,735, 13/273,984, 13/115,690, 13/572,518, 13/630,906 and in issued U.S. Pat. No. 8,468,601 each of which are incorporated herein by reference in their entirety.

Like the exemplary AHM node 130′ and VHM node 140′, the MNT node 150′ includes a customized adapter 325b. The customized adapter 325b is configured to bridge any communication implementation gap between the hierarchical system software and the computing device operating software operating within the various nodes of the hierarchical structure 200.

At the Enterprise (ENT) layer 160, there may be a number of ENT nodes 160′, each ENT node is associated with a particular host computing device that may be in operative communication with one or more sensors and/or actuators of a particular component(s) of the complex system via an EHM node 120′, to subsystems of the complex system and that are in operable communication via their respective AHM node 130′ and the VHM nodes 140′, as well the MNT nodes 150′. As a non-limiting example, the ENT node 160′ may be a general purpose computer that is in wired or wireless communication with the communication system 9 of the hierarchical structure 200.

FIG. 3 also illustrates that the ENT node 160′ may have the functionality of some or all of the executable applications (221-264) as selected and configured by the user. Like the exemplary VHM node 140′, the executable application(s) 260a from the Interact library allow the system user 210 to access the ENT node 160′ node directly via the GUI 170. In their undirected state, the SEAMs 220a, 230a, 240a and 250a are identical to their undirected counterpart application modules (221-264) that may reside in any another node in any other level in the hierarchical structure 200. The executable applications 220a-260a are configured/directed to carry out specific functions via configuration files 185a.

Like the exemplary AHM node 130′, VHM node 140′ and the MNT node 150′, the ENT node 160′ includes a customized adapter 325a. The customized adapter 325a is also configured to bridge any communication or implementation gap between the hierarchical system software and the host computing device software operating within the ENT node.

In various embodiments, none of the computing nodes (120′-160′) are able to communicate directly with one another. Hence, all computing nodes (120′-160′) communicate via the customized adapters 325. In other embodiments, most computing nodes 120′-160′ may communicate via the customized adapters 325. For example, an exception may be an EHM node 120′, which may communicate via its host executive software 330.

A customized adapter 325 is a component of the host executive software 330 and is controlled by that host software. The customized adapter 325 provides an interface between the host executive software 330 and the SEAMs (221-264). The workflow service module 310 will invoke one or more of the SEAMs (221-264) and services (302, 303, 306) to make data available to the customized adapter 325, which places data from a node onto a data bus of the communication system 9 and pulls data from the bus for use by one of the SEAMs (221-264). For example, the Acquire SEAM 221 may receive data from the customized adapter 325, or the Report SEAM 253 may produce data to be placed on the bus by the customized adapter.

The communication system 9 may be any suitable wired or wireless communications means known in the art or that may be developed in the future. Exemplary, non-limiting communications means includes a CAN bus, an Ethernet bus, a firewire bus, spacewire bus, an intranet, the Internet, a cellular telephone network, a packet switched telephone network, and the like.

The use of a universal input/output front end interface (not shown) may be included in each computing node (120′-160′) as a customized adapter 325 or in addition to a customized adapter 325. The use of a universal input/output (I/O) front end interface makes each node behind the interface agnostic to the communications system by which it is communicating. Examples of universal I/O interfaces may be found in co-owned application Ser. No. 12/768,448 and co-owned U.S. Pat. No. 8,054,208, and are examples of communication interface means.

The various computing nodes (120′-160′) of the hierarchical structure 200 may be populated using a number of methods known in the art, the discussion of which is outside the scope of this disclosure. However, exemplary methods include transferring and installing the pre-identified, pre-selected SEAMs to one or more data loaders of the complex system via a disk or other memory device such as a flash drive. Other methods include downloading and installing the SEAMs directly from a remote computer over a wired or wireless network using the complex system model 181, the table generator 183 and the GUI 170. In regard to MNT nodes 150′, MNT nodes may be alternatively populated offline to the extent that they are hosted in portable computing devices.

The data modeling tool 171, table generator 183 and the GUI 170 may be driven by, or be a subsystem of any suitable HMS computer system known in the art. A non-limiting example of such an health maintenance system (HMS) is the Knowledge Maintenance System used by Honeywell International of Morristown N.J. and is a non-limiting example of a model based configuration means. The data modeling tool 171 allows a subject matter expert to model their hierarchical structure 200 as to inputs, outputs, interfaces, errors, etc. The table generator 283 then condenses the system model information into a compact dataset that at runtime configures or directs the functionality of the various SEAMs (221-264) of hierarchical structure 200.

The GUI 170 renders a number of control screens to the system user 210. The control screens are generated by the HMS system or by a maintainer computing device 150′ and provide an interface for the system user 210 to configure each SEAM (221-264) to perform specific monitoring, interpretation and reporting functions associated with the complex system.

FIGS. 4 and 5 are simplified block diagrams of an exemplary computing node (120′-160′). Each computing node (120′-160′) utilizes its own host executive software 330. The host executive software 330 executes the normal operating functions of the host node, but may also provide a platform for hosting additional maintenance functions residing in any SEAM (221-264) populating the computing node as described above. As described above, there are 24 SEAMs (221-264) disclosed herein. However, other SEAMs with additional functionalities may be included. As such, any discussion herein is intended to extend to any SEAMs that may be created in the future.

In the interest of brevity and clarity of the following discussion, the number of SEAMs (221-264) in the following example has been limited. The operation of a lower level computing node such as an EHM node 120′, an AHM node 130′, and an VHM node 140′ utilizes the same basic SEAMS as an MNT node to accomplish basic data processing tasks such as, but not limited to an Acquire SEAM 221, a Decode SEAM 222, Evaluate SEAM 231, a Record SEAM 234 and an Analyze SEAM 232 as these SEAMs may be viewed as providing some basic functionality common to each SEAM resident in each computing node (120′-160′) of the hierarchy, but will be extended to other SEAMs in regards to the basic operation associated with FIG. 9.

In addition to the SEAMs (221-264), each computing node (120′-160′) also includes a configuration file 185 and a workflow service module 310. The configuration file 185 comprises data, variables and instructions stored in the DDS 350b and the SDS 350a. Among other data structures, the DDS 350b may comprise an Event Queue (EVQ) 351, a High Priority Queue (HPQ) 352, a Time Delayed Queue (TDQ) 353, a Periodic Queue (PQ) 354 and an Asynchronous Queue (AQ) 355. However, it will be appreciated by those of ordinary skill in the art that the number of queues, their categorization and their priority may be defined and redefined to meet the requirements of a particular application. For Example, the EVQ 351 may be divided into three or more sub-queues such as an Acquire Event Queue, a Coordinate Event Queue and a User Interface Event Queue. Providing separate sub-event queues resolves any concurrent write issues that may arise.

Referring to FIG. 5, the DDS 350b may also include at least one message buffer 360 for each SEAM (221-264) that has been populated into the MNT node 150′. However, in some embodiments only SEAMs within the Measure Library may have a message buffer. The DDS 350b may also include a number of record snapshot buffers 370 and circular buffers 380 that store particular dynamic data values obtained from the complex system to be used by the various SEAMs (221-264) for various computations as provided for by the configuration file 185. The data stored in each of the message buffers 360, snapshot buffers 370 and circular buffers 380 is accessed using a data accessor 304 which may be any suitable data accessor software object known in the art. The particular data structure and the location in the DDS 350b for the message buffers 360, circular buffers 380 and snapshot buffers 370, are predetermined and are established in a memory device at run time.

The SDS 350a is a persistent software object that is manifested or defined as one or more state machines 361 that map a particular event 362 being read by the workflow service module 310 from the Event Queue (EVQ) 351 to a particular response record 363 (i.e., an event/response relationship). The SDS 350a may also be manifested as a data structure in alternative equivalent embodiments. The state machine 361 then assigns a response queue (352-355) into which the response record 363 is to be placed by the workflow service module 310 for eventual reading and execution by the workflow service module 310. The structure and the location of the persistent data in the SDS 350a is predetermined and is established in a memory device at run time.

As discussed above, access to variables in a message or stored in the SDS 350a for use by a SEAM may be facilitated by the encode and decode utilities 306 using a data masks (1016, 1016′) (“Decode Mask”). A data mask as used herein is a mask applied to a digital word to allow variables 1000 contained in the word to be isolated and stored in a variety of locations and then once retrieved from storage are reconstituted and concatenated into a word 1001. Decode or data masks are structured as a variable start bit and a mask of “1's” that denote the length of the variable.

The exemplary events 362 may be received into the EVQ 351 in response to a message from an outside source that is handled by the customized adapter 325 of the computing node (120′-160′), as directed by the host executive software 330. Events 362 may also be received from any of the populated SEAMs (221-264) resident in the computing node (120′-160′) as they complete a task and produce an event 362.

In the more basic SEAMs such as Sense 223, Acquire 221, Decode 222 and Evaluate 231, the event/response relationships stored within the SDS 350a do not tend to branch or otherwise contain significant conditional logic. As such, the flow of events 362 and response records 363 is relatively straight forward. However, more sophisticated SEAMs such as Coordinate 252, Forecast 255 and Respond 261 may utilize sophisticated algorithms that lead to complicated message/response flows associated with other nodes node.

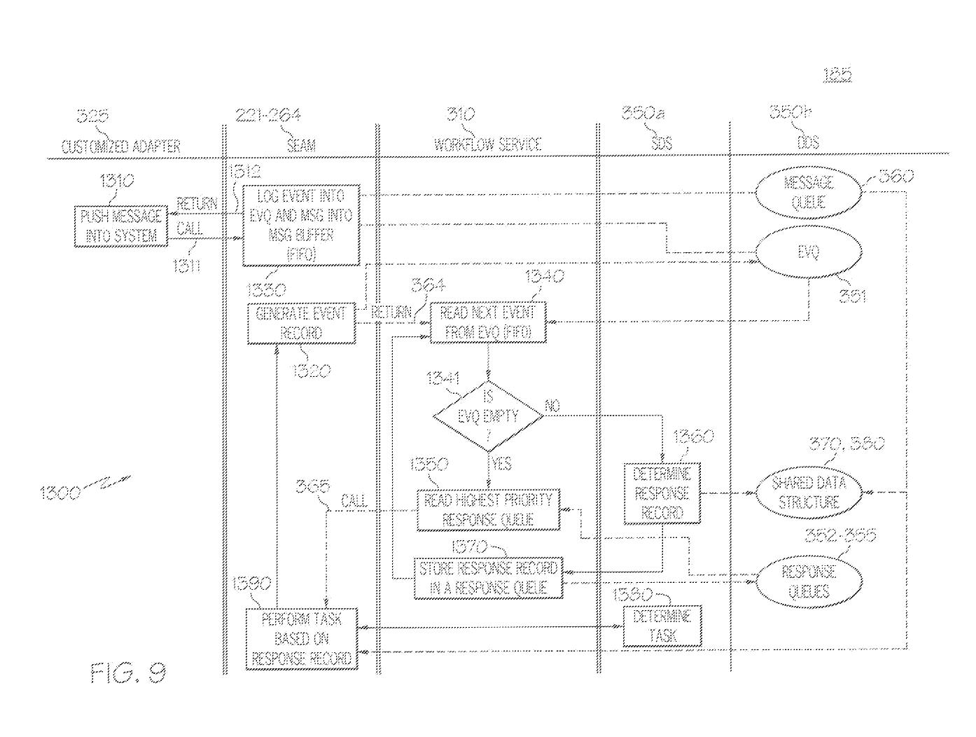

As an operational example of a lower level node, the host executive software 330 may push an input message into an EHM node 120′ that is received from an outside source. Each message, which also may be considered to be a data structure, is of certain type and includes a message identification code (“message ID”). Messages of different types may have the same message ID. How specific message types are manifested is not particularly important, except that the message type coupled with a message ID constitutes a unique identifier for use in accessing and traversing a function augmentation data matrix 900 (See, FIG. 7) that accompanies a user request message 362 (i.e. a user instruction UI) that is received from the originating MNT node 150′ at a lower level node (120′-140′). Internal messages/data blocks are treated similarly in that they are a specific type of message and have a message ID.

When an internal or external message is received, the host executive software 330 calls a customized adapter 325 which in turn calls the appropriate SEAM (221-264) resident in the EHM node 120′ based on data included in the message. For Example, the called SEAM may be the Acquire SEAM 221. When called, the Acquire SEAM 221 places the input message into a message buffer 360 (e.g., the Acquire input message buffer), generates an event 362 and places the event into the EVQ 351. The event 362 may contain data about the complex system from another node or from a local sensor. In the interest of simplicity and clarity of explanation, this first event 362 will be assumed to be an “acquire data” message and the event 362 generated from the input message will be referred to herein as AQe₁. In other embodiments the input message AQ₁ may be generated by another SEAM (221-264) and the event AQₑ₁ pushed into the EVQ 351 by that SEAM.

Once the input message AQ₁ is placed in a message queue 360 and its corresponding event 362 is placed into the EVQ 351, then the Acquire SEAM 221 exits and returns control to the workflow service module 310 via return message 364. In this simple example, only a single processor processing a single command thread is assumed. Thus, while the processor is executing a particular SEAM (221-264), the workflow service module 310 and no other SEAMs are operating. Similarly, while the workflow service module 310 is being operated by the processor, no SEAMS (221-264) are in operation. This is because all steps in the operation are performed sequentially. However, in other embodiments, multiple processors may be used, thereby permitting multiple threads (i.e., multiple workflow service modules 310) to be operated in parallel using the same populated set of SEAMs (221-264) and the same configuration file 185.

Upon receiving the return message 364 (See, FIG. 12), the workflow service module 310 resumes operation and reads event AQₑ₁ first in this example because event AQₑ₁ is the first event 362 in the EVQ 351. This is so because the EVQ 351 is the highest priority queue and because the workflow service module 310 may read events sequentially in a first-in-first-out (FIFO) manner. Therefore those of ordinary skill in the art will appreciate that any subsequent events stored in the EVQ 351 would be read in turn by the workflow server on FIFO basis. However, reading events in a FIFO manner is merely exemplary. In equivalent embodiments, the workflow service module may be configured to read events in some other ordinal or prioritized manner.

Once event AQₑ₁ is read, the workflow service module 310 consults the persistent data structures in the SDS 350a to determine the required response record 363 to the event AQₑ₁. The response record 363 provided by the SDS 350a may, for example, be a decode response record DECᵣ₁ that directs the Decode SEAM 222 to process the data received from the input message AQ₁, and store it in a storage location in the DDS 350b. To do this the Decode SEAM uses the decode utility, which are both resident in utilities library 306, in conjunction with data masks. The interaction of the encode/decode utilities and the SEAM allows the storage and retrieval of a variable to and from multiple locations in a message without having to recode and compile/link instructions (See, FIGS. 12A and 12B).

The SDS 350a also provides data/variables that directs the workflow service module 310 to place the response record DECᵣ₁ into one of the response queues 352-355, such as HPQ 352, and assigns the location in the response queue in which to place the response based on an assigned priority. The SDS 350a may determine the appropriate queue and its priority location in the queue based on the input message type, the data in the input message and on other data such as a priority data field and message ID. The workflow service module 310 places the response record DECᵣ₁ into the HPQ 352 at the proper prioritized location and returns to read the next event in the EVQ 351.

Because the EVQ 351 is the highest priority event/response queue, the workflow service module 310 continues reading events 362 and posts responses records 363 until the EVQ is empty. When the EVQ 351 is empty, the workflow service module 310 begins working on response records 363 beginning with the highest priority response queue (352-355), which in this example is the HPQ 352.

The first prioritized response record in HPQ 352 in this example is the DECᵣ₁ response (i.e., a Decode response). When read, the workflow service module 310 calls (via call 365) a response handler interface of the Decode SEAM 222 for the Decode SEAM to operate on the data referenced in the DECᵣ₁ response record 363.

After being called by the workflow service module 310, the Decode SEAM 222 consults the SDS 350a with the response record DECᵣ₁ to determine what operation it should perform on the data associated with DECᵣ₁ and performs it. As disclosed above, a SDS 350a maps the event DECᵣ₁ to a predefined response record 363 based on the message type and the data referenced within DECᵣ₁. Data associated with event DECᵣ₁ may reside in any of the record snapshot buffers 370, circular buffers 380, or the data may have to be queried for from a source located outside the exemplary node. Data locations for a particular variable (1000, 1000′) commonly exist in multiple storage locations in the SDS 350a and DDS 350b and are identified in the data matrix 900 (See, FIG. 7) in the form of data masks (1016, 1016′).

The Decode SEAM 222 operates on the data and generates an event 362 and places the event into the EVQ 351 and a message into the message queue 360. For example, the response record 363 generated by the Decode SEAM 222 may be EVALₑ₁ indicating that the next process is to be performed by the Evaluate SEAM 231. The Decode SEAM 222 then exits and sends a return message 364 back to the workflow service module 310 to resume its operation. The process begins anew with the workflow service module 310 reading the EVQ 351 because there are now new events (including EVALₑ₁) that have been added to the queue.

In the normal course, the work flow service module 310 eventually reads event EVALₑ₁ and consults the SDS 350a to determine the proper response record 363 and which response queue to place it and in what priority within the response queue. In this example the response EVALᵣ₁ is also placed in the HPQ 352 and is in first priority because the response record DECᵣ₁ would have already been operated on and dropped out of the queue. The workflow service then reads the next event from the EVQ 351, and the process continues.

FIG. 6 is a simplified functional depiction of a modified SDS 350a and a DDS 350b as may exist in a node (120-160). In the SDS 350a there exists variables specifications 1000, word specifications 1001, decode specifications 1002, snapshot specifications 1003, variable offset factors 1004 and data masks 1006 (a.k.a “data masks”), all of which are utilized by a SEAM to instruct the workflow service module 310 to process messages, events and responses as discussed above.

Variable specifications 1000 are static data located in the SDS 350a used by the workflow service module 310 that stores data used to execute various tasks required by SEAMs (221-264). Variable specifications 1000 stored in the SDS 350a do not change. A variable specification comprises a global identification symbol, a data maskstart bit, a storage type, a usage type, an engineering unit scale factor, an engineering unit offset factor, an initial value, an index to the DDS 350b, a byte size, a persistence indicator, a source assembly and a sampling frequency of a variable.

Words 1001 are defined for each data element (field) in a message. Word specifications 1001 in the SDS 350a comprise static 32 bit memory locations that contain a list of ID's for variables 1000 contained within a word. Words also comprise a unique word ID, a source message and data masks in their various forms as may be practiced in the art. A word is a block of continuous N bits with its' start bit located at mod N location in a message. N would typically be the registry size of the processor. If the processor is a 16 bit processor than the word would be a 16 bit word, if it is 32 it would be a 32 bit word.

Decode Specifications (“Decode Specs”) 1002 are static data structures that contain a list of decode or data mask ID's (1016, 1016′) for various words 1001 and variables (1000, 1000′). For each data element, the decode specification 1002 contains information about the location (offset) (1014, 1014′) within the message, its size and similar information for use by the runtime code. Decode specifications also comprise message type 1007 indicators to identify instances of a message(s). The Input/output message buffers 390, circular buffers 380, snapshot specifications, trend specifications and report specifications all have individual data structures and a corresponding decode specification.

Snapshot specifications (“snapshot specs”) 1003 are static storage locations that contain data records that define a time series or a “snapshot” of data that is recorded (i.e., captured) in regard to some component in a complex system. Snapshot specifications also contain a snapshot type ID, a trigger algorithm, data retention rules, a trigger event, a collection interval, snapshot inhibits, append interval times, persistence indicators, and pointer which points to a decode specification data structure for the snapshot specification. A snapshot type ID uniquely identifies a snapshot specification. A snapshot ID is a unique identifier for each instance of a snapshot type that is recorded. The snapshot ID identifies a particular “batch” of data captured according to the snapshot specification (A, B, C . . . n) and has a unique batch identifier (1, 2, 3 . . . n).

A variable offset factor 1004 contains a start bit and a variable decode (or data mask) pointer and one or more additional pointers that point to specific variables 1000 required to execute a task. The variable data mask pointer points to specific data masks (data masks) 1006 stored in the SDS 350a.

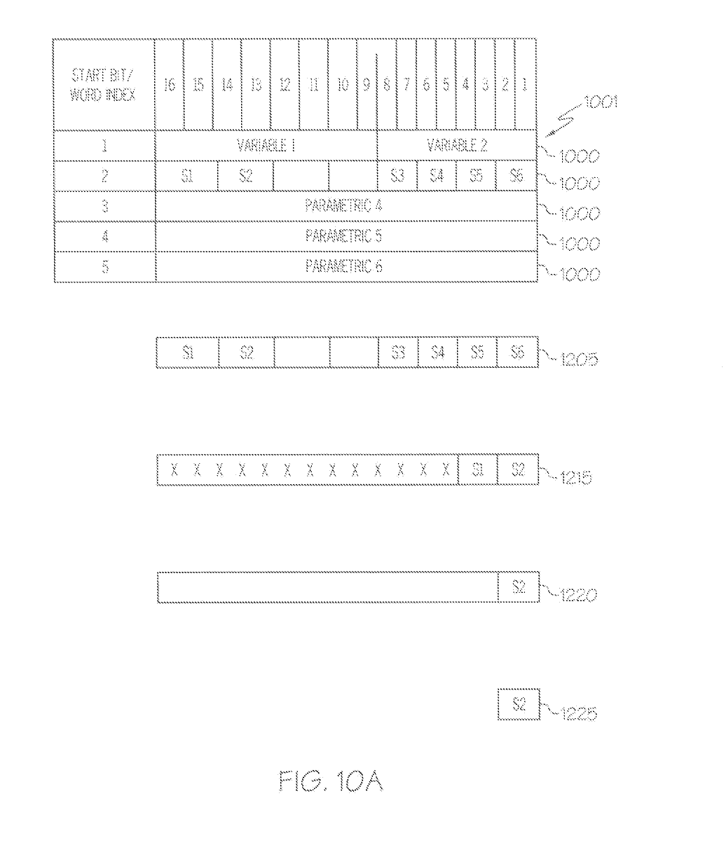

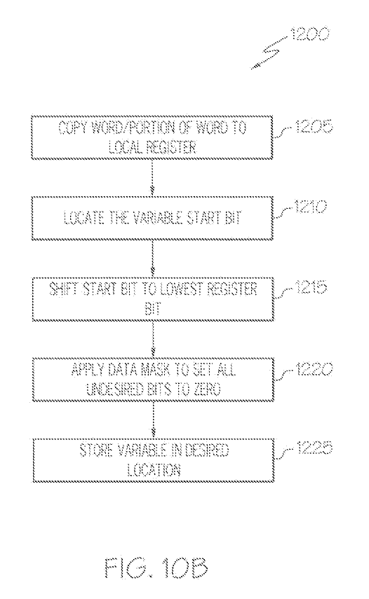

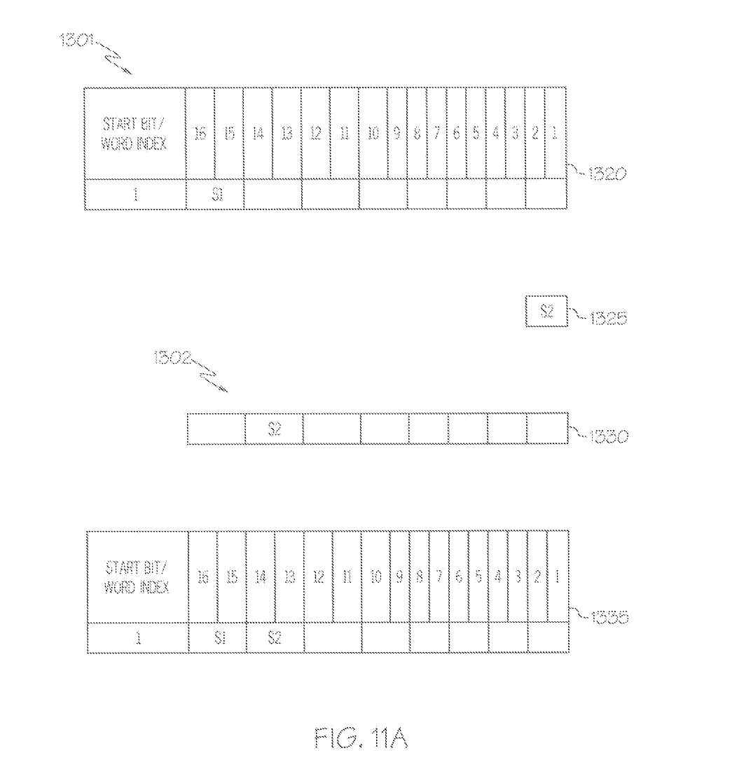

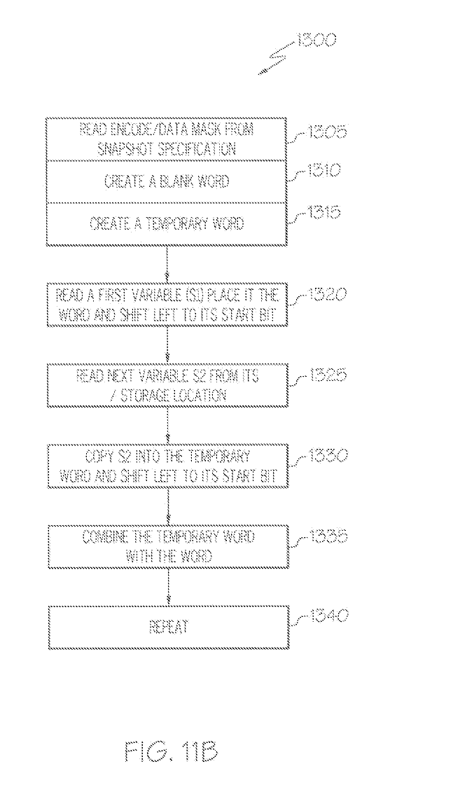

Health maintenance systems utilize many different variables (1000, 1000′). A particular variable may be used for a variety of purposes and be stored in a variety of locations within a memory device. Thus, a quick, efficient means for dynamically locating, retrieving and storing a variable 1000 by a variety of SEAMs (220-260) and the workflow service module 310 is desirable. This may be done by data masking. Data masking is defined herein as the ability to decode a selected piece of data (i.e., a variable) from a data structure or message that contains many pieces of data that are concatenated together (See also, FIG. 10) and encode a selected piece of data (i.e., a variable) into a message being composed contains many pieces of data that are concatenated together. A data mask comprises a start bit in the word for a variable and a hexadecimal mask of (“1's”) indicating the length of a variable.

By utilizing a higher level node computing device (150′,160′), a system user 210 may access an EHM node 120′, AHM node 130′ or VHM node 140′ and change its functionality by creating a SDS extension 1010 within the non-static DDS 350b. An SDS extension is also known as a “data definition” because it defines the data and where the data resides. Each component of the SDS extension 1010 is logically linked to its static counterpart in the SDS 350a such that the SDS extension 1010 appears to the workflow service module 310 to be part of the static SDS 350a. Thus, the SDS extension 1010 comprises a variable extension 1005, a Words extension 1011, a decode specification extension 1012, a snapshot specification extension 1013, a variable offset extension 1014 and its variable storage extension 1021.

Messages to and from a node, such as an input message AQ₁, includes a user generated matrix data 900 that includes identification and health status of a variety of nodes, complex system components, sensors and other data related to the health of the system. It may also contain the results of a request from higher/lower nodes or requests to lower/higher nodes. The content of the matrix is situation specific. Thus, a message includes a data matrix 900 that contains data to allow the SEAMS (220-260) and the Workflow Service module 310 to accomplish the tasks as they are configured to do.

FIG. 7 presents a simplified illustration of the interrelationships between the various data that make up the data matrix 900. The data matrix 900 is an exemplary snapshot data matrix 900 (e.g., a data structure). Matrices for other functions rather than requesting a data snapshot are similar in structure but are not described here in in the interest of clarity and brevity.

Data matrix 900 includes snapshot specifications 1013 that point to an input to a data structure 1012, which comprises a list of word IDs. Each word ID points to a word extension 1011. A word comprises at least a word mask ID and a list of variable offset table IDs.

Word mask IDs point to data masks 1016 for words. Word mask IDs are indicators that uniquely refer to a word or data mask (1016, 1016′).

The list of variable offset IDs points to one or more variable offset tables 1014. A variable offset table points to a data masks 1016 and points to specific variables 1000.

Each variable 1000 includes a storage address in the DDS 350b where the variable is stored and to a data structure in memory where the variable is stored. Thus, a snapshot definition for a variable comprises snapshot specifications 1013, data inputs 1012, words extension 1011, variable offset tables 1014, decode/data masks 1016, the storage areas for the variables 1000 themselves, and also has references to the buffer in DDS where the snapshot instance is stored.

Variable storage area 1020 (See, FIG. 6) is the normal storage area in the DDS 350b that is referenced by the SDS 350a for variables. The variable storage extension 1021 is an extension to the variable storage area 1020 and is referenced via the variable extension 1005 for variables introduced from the matrix data 900 received in a message from the node (150′-160′).

The data matrix 900 also contains information as to where the data referenced in the data matrix 900 will be found in the extension of the SDS extension 1010 that has been created in the DDS 350b. The extension would include a similar set of data 1011′-1014′ and variable instances 1021. In other words, the words extension 1011, data structure (“Decode Spec”) extension 1012, snapshot extension 1013, Variable offset extension 1014, decode (“data”) masks 1016 and variables extension 1005 together define what the data is. The words extension 1011′, Data Structure (Decode Spec) extension 1012′, snapshot extension 1013′, Variable offset extension 1014′, decode (“data”) masks 1016′ and variables extension 1005′ define where the data resides in the memory device.

By using a GUI 461 and a web browser 460, a user creates the function augmentation data matrix 900 defining what data needs to be collected/analyzed by which node (120-160) and includes specifics as to how and when such tasks should be performed. and is pushed in to EVQ 351 for processing by the workflow service of the lower level node.

As mentioned above, higher level node has the capability of modifying the operation of a lower level node (i.e., EHM, AHM or VHM) in essentially real time. This allows a system user 210 to collect and or process data in an ad hoc manner to investigate emergent maintenance issues. For example, a system user 210 may instruct an AHM node 130′ to gather data about a component being monitored by a particular EHM node 120′ that may not be under its normal supervision and to process the data with other stipulated data in order to investigate a particular operating anomaly. This is done by directing the lower level node to create an SDS extension 1010 (See, FIG. 9) of the SDS 350a within the DDS 350b. This technique does not require taking down the system to reconfigure, and reload the DDS 350b and the SDS 350a. It also allows the change to remain a temporary modification.

SDS extension 1010 may be persistent or may be volatile. Typically the SDS extensions 1010 are volatile and erase when powered off as is typical with data stored in volatile memory such as RAM. The SDS extension 1010 may be made persistent if a flag is set by the system user 210 to indicate that the data should be stored in persistent memory such as a flash memory device prior to power down and reloaded from the persistent memory into the DDS 350b at power up.

FIG. 8 illustrates an exemplary event flow diagram for a method that creates the SDS extension 1010 in the DDS and executes the data collection for a node. Messages and events are processed according to the method flow diagram of FIG. 9, which is discussed in regard to FIG. 12 and FIG. 13 of co-owned, co-pending application Ser. Nos. 13/273,984 and 13/077,276, which are incorporated herein by reference in their entirety.

FIG. 10A is a simplified depiction of a message that contains a single word 1001 that is contained in the data matrix 900. The data message may be message AQₑ₁ shown in FIG. 5. The exemplary word 1001 contains 11 variables 1000 of different types (Variable 1, Variable 2, S1-S6, and Parametric 1-4). In order to isolate variable S2 and store it in a memory location a decode/data mask 1016 is applied to it. In this example, the data mask contains a start bit 13 and a variable length of 4 (four) bits and is found in the snap-shot specification message 1013.

FIG. 10B is a method 1200 for using a decode/data mask for isolating and storing a variable (S2) in a word 1001. This process assumes that the variable offset table 1014/variable offset table extension 1014′ stipulates the data mask via the data mask ID as directed by the snapshot message specification 1013. At process 1205, a portion of the word 1001 containing the variable S2 is copied into a local variable register.

At Process 1207 the decode/data mask 1016 for the word is read from the snapshot specification. At process, 1210, the start bit for the variable S2 is located using the start bit in the data mask. In this example, the start bit is bit 13.

At process 1215, the portion of the word is shifted right until the first bit is in the lowest bit position of the register (i.e., bit position 1). It should be noted that although the current example uses a 16 bit word for simplicity of explanation, a 32 bit or larger word is handled in the same manner.

At process 1220, all bits to the left of variable of concern (S2) are set to zero. At this point, variable S2 has been isolate from the word 1001 and may be stored in the desired location as directed at process 1225.

FIGS. 11A and 11B disclose a converse method 1300 to read the variable S2 from a storage location and create a word extension 1011 for use in a message using the exact same data mask (now the “encode mask”) 1016 used to isolate the variable S2 in method 1200.

At process 1305 the encode/data mask 1016 is read from the snapshot specification 1013. At process 1310 a blank word 1301 is created. At process 1315 at blank temporary word 1302 is created. At process 1320, a first variable (S1) first variable is read from memory, placed into the word 1301 and shifted left to its start bit according to its data mask 1016, which in the example of FIG. 11A is bit 15.

At process 1325, a next variable (S2) is read from its memory location and is copied into the temporary word 1320. Variable S2 is the shifted left to its start bit according to its data mask 1016, which in the example of FIG. 11A is bit 13.

At process 1335, the temporary word 1302 and the word are combined into word 1301 and the temporary word is set to zero. Processes 1325-1335 are repeated until the word is complete.

FIGS. 12A/B is a simplified flow chart for an exemplary method 1400 using data masks 1016 (also known as decode masks) to capture a data snapshot of specific parameters generated by a component of the complex system. Method 1400 is part of the standard functionality encoded in a Decode SEAM 222 as configured by configuration file 185. Method 1400 can occur as process 1390 of FIG. 9, as may other tasks.

At process 1406, a trigger condition is met and a SEAM is called. In this example the Record SEAM is called. The Record SEAM allows the computing node (120-160) to collect a data snapshot concerning a component of the complex system under the purview of the computing node. At process 1410, the Record SEAM determines the task to be performed from the message. In this case the task is to start a record.

At process 1412, the appropriate snapshot specification 1013 is read from the SDS 350a by the workflow service module 310 to get direction on how and what data to capture and the process returns to process 1410 where the next task is determined to be to append a data recording. Snapshot specifications 1013 are static storage locations that contain data records that define a times series or a “snapshot” of data that is recorded (i.e., captured) in regard to some component in a complex system. Snapshot specifications also contain a snapshot type ID, a trigger algorithm, data retention rules, a trigger event, a collection interval, snapshot inhibits, append interval times, persistence indicators, and pointer which points to a decode specification data structure for the snapshot specification. A snapshot type ID uniquely identifies a snapshot specification. A snapshot Id is a unique identifier for each instance of a snapshot type that is recorded. The snapshot ID identifies a particular “batch” of data captured according to the specification (A, B, C . . . n) and has a unique batch identifier (1, 2, 3 . . . n). Throughout the rest of this example, reference to the event response process of FIG. 9 is used by the Record SEAM but discussion of which will be omitted in favor of summary steps in the interest of brevity and clarity.

At process 1418, an iterative process begins to capture the requested data. As such, the incoming message requesting the data is read from the event queue 351 by the workflow service module 310 of the computing node using data from the snapshot specification 1013 located in the SDS 350a.

At process 1424, the SEAM reads a decode specification from the SDS 350a by the workflow service module 310 using the message ID as an index. Decode Specifications (“Decode Specs”) 1002 are static data structures that contain a list of ID's for various words 1001. Decode specifications also comprise Message IDs 1007, Message type indicators, a source assembly and sampling frequency. Input/output message buffers 390, circular buffers 380, snapshot specifications, trend specifications and report specifications all have individual data structures (i.e., decode specifications).

At process 1430, a decode facility is called from the utilities library 306. The decode utility 306 may be any suitable decode program that may be known in the art or that is developed in the future and utilizes the data masks 1006/1016 (See, FIGS. 6 and 10B) to store variable data for the snapshot in temporary locations in the DSD extension 1010 at process 1436.

At decision point 1442, when all required data has not been decoded and stored then the process returns to process 1410 where the next tasks is determined. In this example, the next task is to finalize the snapshot for storing at process 1478.

When all required data has been decoded and stored then the method 1400 proceeds to process 1448. At Process 1448, the Record SEAM prepares a snapshot message header for appending to the snapshot data.

At process 1454, an encode specification is read from the snapshot specification 1013 by the workflow service module 310 that includes the data masks 1016 that allow the data variable(s) was captured and stored to be retrieved and placed in an outgoing snapshot message.

At process 1460, the Record SEAM calls the encode utility from utilities package 306 which uses the decode/data masks to retrieve variables 1000 from their various temporary memory locations to create the time sample that is the snapshot data requested. The encode utility may be any suitable encode program known in the art and/or that may be used in the future. Variable specification 1000 is static data located in the SDS 350a that is used by the workflow service module 310 to execute various tasks required by SEAMs (221-264). Variable specification 1000 in the SDS 350a does not change and comprises a global identification symbol, a start bit, a storage type, a usage type, an engineering unit scale factor, an engineering unit offset factor, an initial value, and index to the DDS 350b, a bit size, a persistence indicator, a source assembly and a sampling frequency. A variable offset factor 1004/1014 contains a start bit and a variable data mask pointer and one or more additional pointers that point to specific variables 1000 required to execute a task.

At process 1466 (See, FIG. 12B), the time sample is stored in a temporary memory buffer. When all time samples have been determined to be collected and processed at process 1472, thereby completing the data snapshot, the snapshot is stored into snapshot buffer 379 in the DDS 350b (See, FIG. 5) at process 1478. If not, the process returns to process 1460 until the snapshot data is fully collected and processed.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A system for accessing and storing variables, comprising:
a standardized executable application module (SEAM), which is a basic un-modifiable modular software object that is directed to complete a specific task after retrieving configuration data;
a computer readable storage device containing the configuration data including a data matrix recorded thereon, the computer readable storage device comprising a dynamic data store (DDS) and a static data store (SDS), wherein the DDS includes a temporary storage location expansion to the data matrix recorded in the SDS; and
a workflow service module, the work flow service module including an encode utility and a decode utility, the workflow service module being configured to direct communication between the SDS, the DDS and the SEAM including retrieving a variable from, and storing the variable to, the computer readable storage device based on the encode utility, the decode utility and the data matrix stored in the SDS and in the DDS expansion.

2. The system of claim 1, wherein the data matrix is a cascading set of interrelated data structures that receives a unique input and provides a specific output.

3. The system of claim 2, wherein the data matrix comprises a data definition stored in the SDS and indicates a location in the DDS where the variable is stored.

4. The system of claim 2, wherein the data matrix comprises a data definition stored in the SDS and indicates a location in the DDS where a data mask for the variable is stored.

5. The system of claim 1, wherein the system accesses a desired variable from plurality of locations, comprising:
Receiving a data word by the SEAM, the data word being associated with a specific message type and a specific message ID, wherein the combined message type and the message ID is a unique input to the data matrix, the data matrix defining a data mask of a variable in the data word.

6. The system of claim 5 wherein the system further reads the data mask from the data matrix associated with the variable on the computer readable storage device associated with the unique input.

7. The system of claim 6, wherein the system further
calls a decode utility;
isolate the variable from the data word by applying the data mask to the data word by the decode utility; and
inserts the value of the variable into a storage address in the DDS.

8. The system of claim 1, wherein the system stores a variable value to a storage location comprising:
receiving the variable value embedded in a data word by the SEAM, the data word being associated with a specific message type and a specific message ID, wherein the combined message type and the message ID is a unique input to the data matrix of the configuration data stored on the computer readable storage device, the data matrix defining a storage address of a variable on the computer readable storage device.

9. The system of claim 8 further comprising reading a data mask from the data matrix associated with the variable on the computer readable storage device associated with the unique input.

10. The system of claim 9 further comprising:
calling a encode utility;
positioning the variable in the data word by applying the data mask by the encode utility; and
storing the word value into the storage location for the unique input.

11. A method for accessing a desired variable from a plurality of locations in a message, comprising:
receiving a data word by a SEAM, the SEAM being a basic un-modifiable modular software object that is directed to complete a specific task after retrieving configuration data, the data word being associated with a specific message type and a specific message ID, wherein the combined message type and the message ID is a unique input to a data matrix of a configuration file, the data matrix defining a data mask of a variable in the data word;
reading the data mask from the data matrix associated with the variable from the data matrix on the computer readable storage device associated with the unique input;
calling a decode utility;
isolating the variable from the data word by applying the data mask to the data word by the decode utility; and
inserting the value of the variable into a storage address in the DDS.

12. The method of claim 11 further comprising:
receiving a request for the variable value by another SEAM, the variable being associated with a specific message type and a specific message ID, wherein the combined message type and the message ID is a second unique input to a data matrix of a configuration file stored on a computer readable storage device, the data matrix defining a storage address of the variable on the computer readable storage device;
reading the data mask stored in the data matrix associated with the variable on the computer readable storage device associated with the second unique input;
calling a encode utility;
positioning the variable in the data word by applying the data mask by the encode utility; and
storing the word into a storage address for the second unique input.

13. A method for storing a variable value to a storage locations, comprising:
receiving a variable value embedded in a data word by a SEAM, the SEAM being a basic un-modifiable modular software object that is directed to complete a specific task after retrieving configuration data, the variable being associated with a specific message type and a specific message ID, wherein the combined message type and the message ID is a unique input to a data matrix of a configuration file stored on a computer readable storage device, the data matrix defining a storage address of the variable on the computer readable storage device;
reading one data mask stored in the data matrix associated with the variable on the computer readable storage device associated with the unique input;
calling a encode utility;
positioning the variable in the data word by applying a data mask by the encode utility; and
storing the data word into a storage address for the unique input.

14. The method of claim 13, further comprising:
receiving the data word by another SEAM, the data word being associated with a specific message type and a specific message ID, wherein the combined message type and the message ID is a second unique input to a data matrix of a configuration file, the data matrix defining a data mask of a variable in the data word;
reading the data mask from the data matrix associated with the variable on the computer readable storage device associated with the second unique input;
calling a decode utility;
isolating the variable from the data word by applying the data mask to the data word by the decode utility; and
inserting the value of the variable into a storage address.
